(19) United States
(12) Patent Application Publication
(10) Pub. No.: US 2006/0127207 A1
(43) Pub. Date: Jun. 15, 2006

(54) Harvesting apparatus

(76) Inventor: Thomas Robert Corbett, Westhope (GB)

Correspondence Address: Skinner & Associates, 212 Commercial Street, Hudson, WI, 54016, US

(21) Appl. No.: 10/530,691

(22) PCT Filed: Sep. 23, 2003
(86) PCT No.: PCT/GB03/04069

§ 371 Date: Aug. 12, 2005

(30) Foreign Application Priority Data
Oct. 11, 2002 (GB) 0223683.4

(51) Int. Cl. B60P 1/00

(52) U.S. Cl. 414/508

(57) ABSTRACT

Harvesting apparatus (10) has a support structure (12), a plurality of driven rotatable members (14) by which the support structure (12) can be moved, and a body support element (16) supported by the support structure (12). The body support element (16) is able to support a picker (22) and is slidable relative to the support structure (12) so that, when the harvesting apparatus (10) is moving in a first direction, the body support element (16) can be selectively positioned relative to the support structure (12) to optimise the portion of the picker (22) relative to the occurrence of produce to be picked. Preferably, a conveyor system (18) and collection area (20) are also included on the support structure (12). The conveyor system (18) enables transportation of produce placed thereon by the picker to the collection area (20) for packing. A method is also provided.

The present invention relates to harvesting apparatus for hand picking of field-grown produce and in particular, but not exclusively, to ground-level field-grown produce.

Harvesting apparatus on which a picker can sit or lie is known. The harvesting apparatus is moved along the rows of the field and the picker picks the produce as it is approached. The picked produce is placed in a suitable container for packing on a separate, independent machine or at a later date.

The problem with this type of apparatus is the irregularity of the produce. At some points along the rows, the produce may be sparse, while at other points there will be clusters. This enables the apparatus having to repeatedly adjust its speed or even stop and start.

A further problem then occurs when the apparatus is intended to support more than one picker to enable picking of produce from adjacent rows. In this case, it becomes in increasingly problematic to adjust the speed of the harvesting apparatus to suit each picker.

Once the container in which the picked produce has been placed is full, the container must be emptied before further picking can take place. This entails halting the picking of the produce, which is undesirable.

A further disadvantage that has been recognised is the need for the full containers to be transferred to a separate packing station. Again, this results in wasted time and, as a consequence, is undesirable.

The present invention seeks to overcome these problems.

According to a first aspect of the present invention, there is provided harvesting apparatus for use when manually harvesting field-grown produce, the harvesting apparatus having a support structure, a plurality of driven rotatable members by which the support structure can be moved, and a body support element supported by the support structure, the body support element being able to support a picker, as hereinbefore defined, and being movable over an extended range relative to the support structure so that the body support element can be selectively positioned relative to the support structure.

Preferable and/or optional features of the first aspect of the present invention are set forth in claims 2 to 15, inclusive.

According to a second aspect of the present invention, there is provided a method of manually hand-picking produce arranged in rows using harvesting apparatus as claimed in any one of the preceding claims, the method comprising the steps of:

a) a picker positioning him, or her, -self on a body support element of the harvesting apparatus;

b) driving the harvesting apparatus along the rows of the produce; and

c) the picker manually hand-picking the produce as it approaches, and selectively moving the body support element over the extended range to optimise the position of the picker relative to the occurrence of the produce, so that an increase in the amount of produce picked and an increase in the speed of movement of the harvesting apparatus can be obtained.

Preferable and/or optional features of the present invention are set forth in claims 17 to 19, inclusive.

According to a third aspect of the present invention, there is provided harvesting apparatus for use when manually harvesting field-grown produce, the harvesting apparatus having a support structure, a plurality of drive rotatable members by which the support structure can be moved, a plurality of body support elements supported by the support structure and on which pickers, as hereinbefore defined, can be supported to harvest the said produce, a collection area at which the harvested produce is deposited, and a conveyor system which transports the harvested produce from the picker to the collection area.

The present invention will now be described, by way of example, with reference to the drawings, in which:

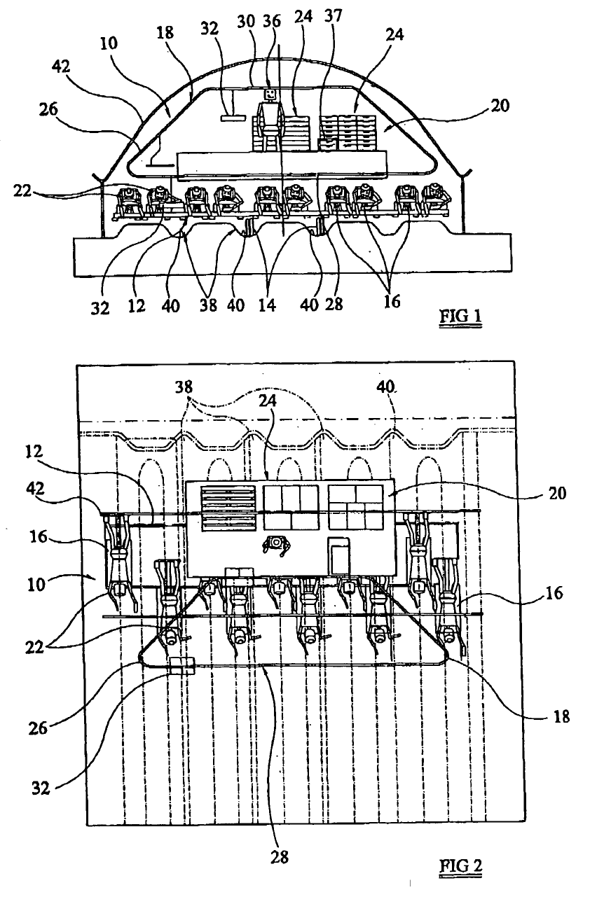

FIG. 1 is a schematic front elevational view of one embodiment of harvesting apparatus, in use, in accordance with the first aspect of the present invention;

FIG. 2 is a schematic top plan view of the harvesting apparatus;

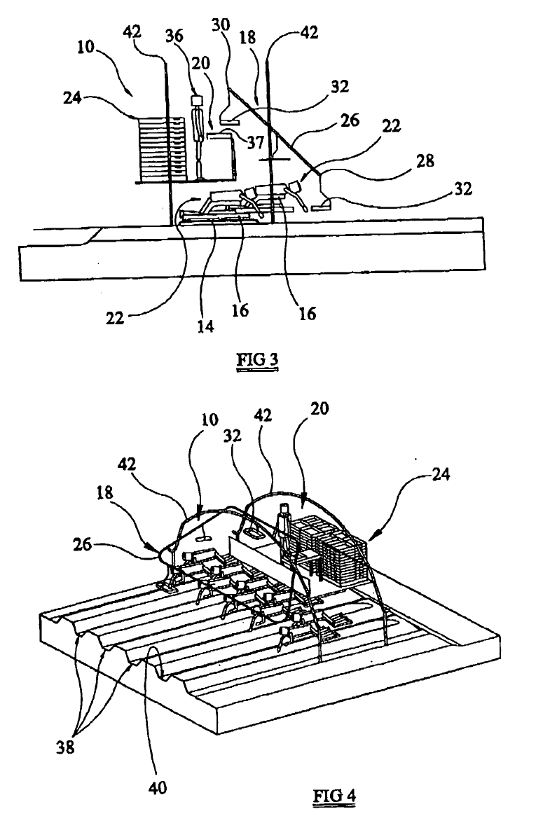

FIG. 3 is a schematic side elevational view of the harvesting apparatus;

FIG. 4 is a schematic perspective view of the harvesting apparatus; and

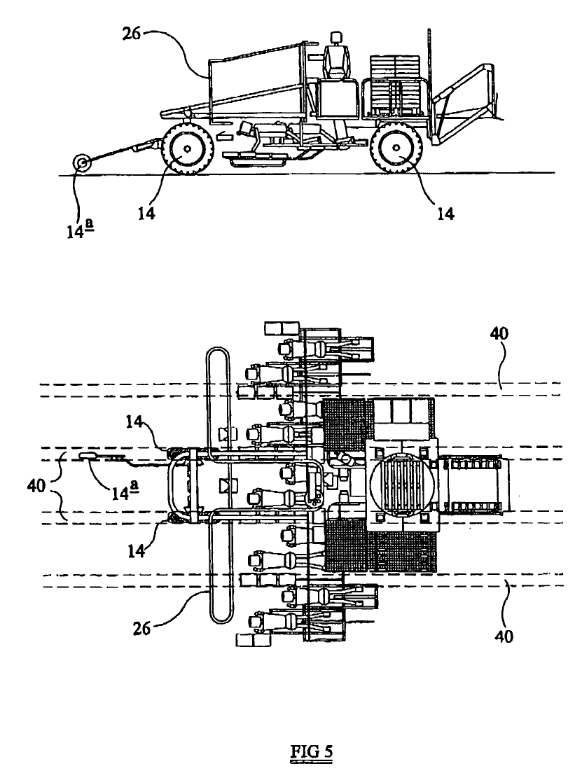

FIGS. 5 and 6 are views illustrating an alternative apparatus.

Referring to FIGS. 1 to 4 of the drawings, here is shown harvesting apparatus 10 having a support structure 12 (only shown in part), a plurality of rotatable members 14, such as wheels or endless caterpillar tracks, mounted on a chassis of the support structure 12, means (not shown) for driving the rotatable members 14, and a plurality of body support elements 16 supported by the support structure 12. A conveyor system 18 and a collection area 20 are also supported by the support structure 12.

The body support element 16 is an elongate padded bed or bench suitably formed to enable a first user 22 (herein referred to as a ‘picker’) to lie prone facedown thereon.

Each body support element 16 is mounted on a linear runner or pair of linear runners (not shown), fixedly supported on the support structure 12, so that the body support elements 16 are slidable relative to the support structure 12. There is thus an extended range of travel or movement, which is greater than that which would be achievable by simply flexing or bending the human body when in a prone position, from one end of the runner(s) to the other. The extended range of movement is in the order of 1 metre, but may be more.

Motorised means (not shown) are provided so that, by operation of a switch (not shown), each body support element 16 can be individually and selectively driven along its runner(s). The switch is typically a foot operated switch located at, or adjacent to, the rear of the body support element 16.

Each body support element 16 can be adjusted in a direction transverse to the longitudinal extent of the runner(s), so that the horizontal distance between adjacent body support elements 16 can be changed.

Each body support element 16 can also be adjusted vertically to alter the spacing between the respective body support element 16 and the ground.

The horizontal and vertical adjustment are effected via a motorised or manually-operated mechanism (neither of which is shown).

The collection area 20 is supported above the body support elements 16 and offset rearwardly relative thereto. The collection area 20 has space to accommodate a plurality of stacks of packing containers 24. The drive of the rotatable members 14 may also be controlled from the collection area 20.

The conveyor system 18 includes an endless rigid, or substantially rigid, conveyor track 26 mounted on the support structure 12, so that a first run 28 of the conveyor track 26 passes adjacent to the fronts of the body support elements 16 and a second run 30 passes through or adjacent to the collection area 20. Receiving members, typically in the form of trays 32, are suspended from the conveyor track 26 and are drivable around the conveyor track 26 through any conventional driving mechanism (not shown). The suspended height of each tray 32 is such that it travels along the first run 28 in or substantially in the horizontal plane of the body support elements 16, and adjacent to the fronts of the body support elements 16. The second run 30 of the conveyor track 26 is arranged so that the trays 32 travel at a height to enable convenient access thereto by a second user 36 (herein referred to as a ‘packer’).

In use, the harvesting apparatus 10 is manoeuvred into position adjacent to a first set of rows 38 having produce to be picked, so that the rotatable members 14 align or substantially align with the troughs 40 of the rows 38. Each picker 22 horizontally adjusts his, or her, allocated body support element 16 to correspond to their allocated row and the pitch of the rows. Each picker 22 also vertically adjusts the body structure element 16 to take account of their body size and arm length.

Each picker 22 then lies facedown on the body support element 16.

The packer 36 starts and controls the harvesting apparatus 10, so that it preferably moves down the rows at a constant or substantially constant speed. The conveyor system 18 is also started.

Due to the movement of the harvesting apparatus 10, each picker 22 picks the produce in their row as it approaches. The picker 22 operates their sliding body support element 16, via their foot switch, to slide in a forwards or backwards direction relative to the support structure 12 of the harvesting apparatus 10. This has the effect of temporarily increasing or decreasing the speed of the picker 22 relative to the support structure 12, so that the picker 22 can optimise their position relative to the occurrence of the produce. Consequently, more produce can be reached, while a higher constant forward speed of the harvesting apparatus 10 can be maintained.

As the produce is picked, it is placed on a passing tray 32. The tray 32 passes around the conveyor track 26 to the collection area 20, where the produce is removed by the packer 36 and packed in one of the packing containers 24.

The collection area 20 includes a packing surface 37 which can be used for quality control of the picked produce, weighing the produce, and so forth.

When the harvesting apparatus 10 reaches the end of the first set of rows 38, it is manoeuvred into position adjacent a further set of rows (not shown) ready for the produce in these further rows to be picked.

Typically, the sets of rows are housed within individual growing tunnels (supporting ribs of which are referenced as 42 in the Figures), which provide an improved growing environment. In this case, the harvesting apparatus 10 is dimensioned to be able to move within the growing tunnel, and the number of body support elements 16 is a multiple of the number of rows housed therewithin.

Obviously, the speed of the harvesting apparatus can be altered as it is travelling along the rows, or the harvesting apparatus can indeed be halted at any point. The drive of the rotatable members could be controlled by a picker from the body support element, for example.

In a modification to the invention, the body spot elements could be manually slidable as opposed to being motorised.

Furthermore, the harvesting apparatus could be adapted to accommodate only a single slidable body support element for a single picker.

The slidable body support element could also be adjustable to enable a picker to be selectively supported in a sitting position and a prone position.

Although the body support elements are slidable, they could be movable in any other suitable way, such as being swingable or pivotable, provided the extended range of movement, beyond that which is capable simply by flexation or bending of the human body when in a prone position, is permitted.

Although the harvesting apparatus is mainly intended for use with the manual hand-picking of ground-level field-grown produce, such as strawberries, it could be adapted for use with other types of field-grown produce requiring manual hand-picking.

The driving means may include feedback control for automatically adjusting the movement of the harvesting apparatus. For optimising the speed of movement, position sensors, or any other suitable alternative, can be included which determine the position of the body support elements and which output signals to control circuitry whereby the driving means determines the optimum speed of the harvesting apparatus which allows the body support elements to remain as close to the centre of their respective runners as possible. Consequently, body support elements will not often be at the limits of their runners.

Further sensors can be used to sense the gaps in between rows of produce and to output signals by which the driving means can automatically steer the harvesting apparatus. This allows pickers and packers to concentrate on the picking and packing of thee produce, respectively.

The pickers may have one or more individual punnet containers carried in one hand, or removably supported by a holder (not shown) fixed to the body support element. Once the punnet container is suitably full, it can be placed on a passing tray for transportation to the collection area. Empty punnet containers are then placed on the passing trays for transportation back to the pickers.

The packing surface of the collection area can thus be used for putting lids on the punnet containers and/or labelling the punnet containers prior to packing.

Also, a GPS-type monitoring system may be provided as part of the harvesting apparatus. This will enable monitoring and recordal of an amount of produce picked, and consequently enable predictive forecasting of expected future produce amounts. For example, the packer at the collection area is provided with a GPS transmitting device. When a predetermined number of packing containers are filled, notification is sent via the GPS device. The resultant amount of produce between consecutive notifications can then be determined based on the distance travelled by the harvesting apparatus. Alternatively, each body support element may be provided with a switch which operates each time a load of produce, for example a punnet container, is moved onto the conveyor system. Yields from every row can thus be monitored.

The harvesting apparatus is intended to be a single independent unit based around a unitary support structure. However, the harvesting apparatus could be split into units which are interconnected and/or bridged, for example a body support element unit and a collection area unit interconnected or bridged via the conveyor system.

By the provision of the body support element with extended range of movement, it is thus possible to provide harvesting apparatus which can be driven along rows of produce at relative high speed while the position of the or each body support element relative to the support structure of the harvesting apparatus, can be optimised based on the occurrence of produce to be picked.

The configuration of the harvesting apparatus need not be as described hereinbefore. FIGS. 5 and 6 illustrate an alternative configuration in which the location of the area in which the packer works has ben changed slightly, the route followed by the conveyor 26 is altered, and the apparatus is supported on four wheels 14, rather than tracks as may be the case in the arrangement shown in FIGS. 1 to 4. An additional wheel 14a extends forwardly of the apparatus, the wheel riding along one of the troughs 40 and serving to assist in steering of the apparatus, leaving the packer free to attend to packing of the picked crop rather than having to concentrate on steering the apparatus.

The embodiments described above are given by way of example only, and modifications will be apparent to persons skilled in the art without departing from the scope of the invention as defined by the appended claims. For example, the horizontal and vertical adjustment of the body support element could be dispensed with; and the body support element could be movable over an extended range in more than one direction.

1. Harvesting apparatus for use when manually harvesting field-grown produce, the harvesting apparatus having a support structure, a plurality of driven rotatable members by which the support structure can be moved, and a body support element supported by the support structure, the body support element being able to support a picker, as hereinbefore defined, and being movable over an extended range relative to the support structure so that, when the harvesting apparatus is moving in a first direction, the body support element can be selectively positioned relative to the support structure.

2. Harvesting apparatus as claimed in claim 1, wherein a plurality of the movable body support elements is provided.

3. Harvesting apparatus as claimed in claim 1, wherein the extended range of movement is in the order of 1 metre or more.

4. Harvesting apparatus as claimed in claim 1, wherein the or each body support element includes motorised means for adjusting the position of the body support element relative to the support structure.

5. Harvesting apparatus as claimed in claim 1, wherein the or each body support element is manually movable.

6. Harvesting apparatus as claimed in claim 1, wherein the or each body support element is slidable along a linear runner or pair of linear runners fixedly supported on the support structure.

7. Harvesting apparatus as claimed in claim 1, wherein the or each body support element is vertically adjustable relative to the support structure to suit an individual picker.

8. Harvesting apparatus as claimed in claim 1, wherein the or each body support element is adjustable in a transverse direction.

9. Harvesting apparatus as claimed in claim 1, wherein the or each body support element is adapted to enable the respective picker to lie prone thereon.

10. Harvesting apparatus as claimed in claim 1, further comprising a conveyor system and a collection area, the conveyor system transporting produce placed thereon by the picker to the collection area for packing.

11. Harvesting apparatus as claimed in claim 10, wherein the conveyor system includes an endless rigid track which is supported by the support structure and from which receiving members are suspended.

12. Harvesting apparatus as claimed in claim 10, wherein the collection area is supported by the support structure.

13. Harvesting apparatus as claimed in claim 1, further comprising means for optimising the speed of the driven rotatable members based on the position of the or each body support element relative to the support structure.

14. Harvesting apparatus as claimed in claim 13, wherein the speed optimisation means includes one or more position sensors which monitor the position of the or each body support element.

15. Harvesting apparatus as claimed in claim 1, further comprising one or more sensors through which the direction of movement of the harvesting apparatus can be automatically adjusted.

16. A method of manually hand-picking produce arranged in rows using harvesting apparatus as claimed in any one of the preceding claims, the method comprising the steps of:
a) a picker positioning him, or her, -self on a body support element of the harvesting apparatus;
b) driving the harvesting apparatus along the rows of the produce at a constant or substantially constant speed; and
c) the picker manually hand-picking the produce as it approaches, and selectively moving the body support element over the extended range to optimise the position of the picker relative to the occurrence of the produce, so that an increase in the amount of produce picked and an increase in the speed of movement of the harvesting apparatus can be obtained.

17. A method as claimed in claim 16, further comprising a step (d), prior to step (a), of adjusting the relative vertical and/or transverse position (s) of the body support element to suit the picker.

18. A method as claimed in claim 16, further comprising a step (e), subsequent to step (c), of placing the picked produce on the conveyor system.

19. A method as claimed in claim 18, further comprising a step (f), subsequent to step (e), of a packer at the collection area removing the picked produce from the conveyor system and packing the picked produce.

20. Harvesting apparatus for use when manually harvesting field-grown produce, the harvesting apparatus having a support structure, a plurality of driven rotatable members by which the support structure can be moved, a plurality of body support elements supported by the support structure and on which pickers, as hereinbefore defined, can be supported to harvest the said produce, a collection area at which the harvested produce is deposited, and a conveyor system which transports the harvested produce from the picker to the collection area.

21. (canceled)
